(19) United States
(12) Patent Application Publication
(10) Pub. No.: US 2025/0119852 A1
(43) Pub. Date: Apr. 10, 2025

(54) RMA GENERATION

(71) Applicant: Nokia Technologies Oy, Espoo (FI)

(72) Inventors: Jianguo LIU, Shanghai (CN); Zhijie YANG, Shanghai (CN); Yan MENG, Shanghai (CN); Tao TAO, Shanghai (CN); Orhan Okan MUTGAN, Munich (DE); Wenjian WANG, Shanghai (CN)

(21) Appl. No.: 18/867,972

(22) PCT Filed: May 31, 2022
(86) PCT No.: PCT/CN2022/096143

§ 371 Date: Nov. 21, 2024

(51) Int. Cl. H04W 56/00; H04L 61/50; H04L 101/622

(52) U.S. Cl. CPC H04W 56/001; H04L 61/50; H04L 2101/622

(57) ABSTRACT

A device, method, apparatus and computer readable storage medium for RMA generation are disclosed. A first device performs timing synchronization with a second device (210). The first device generates, at a first time instance, a first random media access control address, RMA, in accordance with a rule configuration information, to communicate with the second device (220). Further, the first device generates, at a second time instance, a second RMA in accordance with the rule configuration information to communicate with the second device (230). The rule configuration information comprises time instructions comprising information corresponding to the first time instance, and information on a period of time starting from the first time instance and ending at the second time instance.

### FIELD

Example embodiments of the present disclosure generally relate to the field of communications, and in particular, to a device, method, apparatus and computer readable storage medium for random media access control (MAC) address, random MAC address, (RMA) determination.

### BACKGROUND

Today, the evolution of wireless systems has brought privacy concerns to the forefront, driven by user demand and General Data Protection Regulation (GDPR) requirements. The global wireless industry is faced with the growing need to protect users' personally identifiable information from increasingly sophisticated user-tracking and user-profiling activities, while continuing to improve wireless services and the user experience.

### SUMMARY

Example embodiments of the present disclosure provide devices, methods, apparatus and computer readable storage media for RMA generation.

In a first aspect, a method is provided. In the method, a first device performs timing synchronization with a second device. The first device generates, at a first time instance, a first random media access control address, RMA, in accordance with a rule configuration information, to communicate with the second device. Further, the first device generates, at a second time instance, a second RMA in accordance with the rule configuration information to communicate with the second device. The rule configuration information comprises time instructions comprising information corresponding to the first time instance, and information on a period of time starting from the first time instance and ending at the second time instance.

In a second aspect, a device is provided which comprises at least one processor and at least one memory including computer program code. The at least one memory and the computer program code are configured to, with the at least one processor, cause the device to perform timing synchronization with a second device. The device is further configured to generate, at a first time instance, a first random media access control address, RMA, in accordance with a rule configuration information, to communicate with the second device. Further, the device is configured to generate at a second time instance, a second RMA in accordance with the rule configuration information to communicate with the second device. The rule configuration information comprises time instructions comprising information corresponding to the first time instance, and information on a period of time starting from the first time instance and ending at the second time instance.

In a third aspect, there is provided an apparatus comprising means for performing the method according to the first aspect.

In a fourth aspect, there is provided a computer readable storage medium comprising program instructions stored thereon. The instructions, when executed by a processor of a device, cause the device to perform the method according to the first aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which example embodiments of the present disclosure can be implemented;

FIG. 2 illustrates a flowchart of an example method 200 according to some example embodiments of the present disclosure.

FIG. 3 illustrates a signaling flow between the first device and the second device according to some example embodiments of the present disclosure:

FIG. 4 illustrates an example process for periodical RMA generation according to some example embodiments of the present disclosure:

FIG. 5 illustrates an example process for STA-triggered RMA generation according to some example embodiments of the present disclosure;

FIG. 6 illustrates an example process for AP-triggered RMA generation according to some example embodiments of the present disclosure; and

FIG. 7 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device via which services can be provided to a terminal device in a communication network. As an example, the network device may comprise a base station. As used herein, the term “base station” (BS) refers to a network device via which services can be provided to a terminal device in a communication network. The base station may comprise any suitable device via which a terminal device or UE can access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like.

As used herein, the term “terminal device” or “user equipment” (UE) refers to any terminal device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to the base station on predetermined schedules, when triggered by an internal or external event, or in response to requests from the network side.

Examples of the UE include, but are not limited to, smart phones, wireless-enabled tablet computers, laptop-embedded equipment (LEE), laptop-mounted equipment (LME), wireless customer-premises equipment (CPE), sensors, metering devices, personal wearables such as watches, and/or vehicles that are capable of communication. For the purpose of discussion, some example embodiments will be described with reference to UEs as examples of the terminal devices, and the terms “terminal device” and “user equipment” (UE) may be used interchangeably in the context of the present disclosure.

As an example, the terminal device may comprise a station (STA) which is a logical entity that includes a physical layer interface for MAC and wireless communications. The STA includes APs and non-AP STAs. The mobile terminal operated by the user corresponds to a non-AP STA among the STAs. If simply called an STA, then a STA may correspond to a non-AP STA. A Non-AP STA may be called by another name such as a terminal, Wireless Transmission/Reception Unit (WTRU), User Equipment (UE), Mobile Station (MS), Mobile Terminal, Mobile Subscriber Unit, or the like.

As used herein, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the terms “first”, “second” and the like may be used herein to describe various elements, these elements should not be limited by these terms. These terms are only used to distinguish one element from another. For example, a first element could be referred to as a second element, and similarly, a second element could be termed a first element, without departing from the scope of example embodiments. As used herein, the term “and/or” includes any and all combinations of one or more of the listed terms.

As used herein, the term “rule configuration information” may be used to relate to information that is useful (or used) for setting up (i.e. configuring) a rule based on which an RMA is to be generated.

As used herein, the term “pre-association phrase” means before an association between both sides is started. The term “post-association” means after association between both sides is completed and a security context is established. The term “during associating” means a association phase during the authentication or (re) association request/response exchange.

In the third generation partnership project (3GPP), there are some discussions about MAC address determination. In 802.11 standards, the STAs use the fixed unencrypted MAC address in frame headers, which causes a security concern by allowing others to track STAs based on their MAC addresses. To prevent the STA from being tracked and improve the privacy of the Institute of Electrical and Electronics Engineers (IEEE) 802.11, the recent 802.11aq amendment defines MAC address randomization behavior for a non-AP STA. According to IEEE 802.11aq, the non-AP STA should periodically change its MAC address to a random value while not associated to a basic service set (BSS), which is also referred to as pre-association randomization of MAC address. The non-AP STA keeps a single MAC address while being connected to an enhanced service set (ESS). To put differently, a non-AP STA may change its MAC address before connecting to the BSS/ESS, but shall not change its MAC address for the duration of its connection. For example, in the pre-association phase (for example, discovery phase), the STA can send the probe request frames with different RMAs. However, the STA may keep a single RMA when it is to connect with the AP for association/authorization process and data connection.

However, IEEE 802.11aq has limited capability for privacy, and fails to define a detailed mechanism. Moreover, some Randomized and Changing MAC Addresses (RCM) implementations are vendor-specific, such as how often a non-AP STA should change its MAC address. Besides, the usage of STA MAC address in IEEE 802.11aq opens the door to several attack possibilities and privacy risks. For example, maintaining an MAC address constant for a long period of time and associating it to specific networks allows the correlation of information such as correlation between the data generated by devices at home, physically observable events, and identity of the devices (for example, MAC address), thus causing potentially leaking private data about the users' behavior. Besides, maintaining an MAC address constant for a long period of time and associating it to specific networks allows correlation between the presence of an MAC address in a network and the presence of the user in a certain place, thus causing tracking of the user movements.

Striving to address these challenges caused by RCM, the IEEE 802 Local Area Network (LAN)/Metropolitan Area Network (MAN) Standards Committee has formed two standardization projects within the IEEE 802.11 Wireless LAN Working Group, that is, IEEE P802.11bh and IEEE P802.11bi. IEEE P802.11bh considers specific issues related to 802.11 MAC address randomization, and intends to develop an amendment to IEEE 802.11 that addresses them. The goal is to preserve the efficiency of existing services that might otherwise be restricted, such as network support, diagnostics, and troubleshooting, and to reliably detect a device's arrival in a trusted network environment. IEEE P802.11bh intends to also design mechanisms to optimize the user experience when a device's MAC address is changing. IEEE P802.11bi considers privacy concerns, beyond MAC address randomization, from a broader, longer-term perspective. It intends to address and standardize privacy solutions to prevent tracking of a user location and movement.

Currently, IEEE 802.11bh focuses on non-AP STA identification through MAC randomization in pre-association phase, while non-AP STA still does not change MAC address after association (i.e., post-association) as in 802.11aq. On the other hand, IEEE 802.11bi intends to address privacy concerns as a part of its work and manage to solve the case where non-AP STA can also change its MAC address after association, for example, to enable the post-association randomization of MAC addresses for device identification. Further, IEEE 802.11bi proposes rotating MAC address over the air solution to address this issue.

In summary, previously defined IEEE 802.11aq proposes that a non-AP STA may change its MAC address. However, its implementation is limited and mostly vendor-specific. STA can only change its MAC address before association, and no further details are proposed for security. While IEEE 802.11bh tries to address the problems 802.11aq faces and to extend it to a more reliable and secure principles, but it still focuses on pre-association MAC randomization. For both IEEE 802.11aq and its enhanced successor IEEE 802.11bh, the MAC address stays constant while the STA remains associated with the ESS (for example while keeping data connectivity with AP or roaming between APs in the ESS). In other words, even though a non-AP STA can change it MAC address frequently before association and can be identified successfully by the AP, it has to keep the same MAC address as long as it is associated with the AP. But using the same MAC address constantly after association may cause user privacy risk.

To reduce the risk from being tracked, IEEE 802.11bi tries to solve privacy concerns from a broader, longer-term perspective, in which a non-AP STA can also change its MAC address after association. It is proposed that a straightforward solution is to reduce the time the MAC address is used for example, frequent MAC address rotation. However, frequent MAC address rotation potentially requires a non-AP STA to disassociate/re-associate often to change its MAC address, and the frequent attempts to change MAC address may lead to some potential problems. For example, because the STA probably needs to disassociate/re-associate to change its MAC address, user experience may be degraded due to connection outage. Moreover, the management frame overhead may also increase because excessive disassociation/re-association operations may lead to increased number of management frame exchanges.

Besides, by now, there does not seem to exist an effective way to address the privacy and device identification concerns of MAC address randomization that would work for both 802.11bh and 802.11bi requirements. There does not seem to exist an effective way to enable the non-AP STA to randomize its MAC address before or after association with device identification and privacy guaranteed.

Example embodiments of the present disclosure provide a scheme of RMA generation. With the scheme, a device (referred to as a first device) performs timing synchronization with another device (referred to as a second device). The first device generates, at a first time instance, a first random media access control address, RMA, in accordance with a rule configuration information, to communicate with the second device. Further, the first device generates, at a second time instance, a second RMA in accordance with the rule configuration information to communicate with the second device. The rule configuration information comprises time instructions comprising information corresponding to the first time instance, and information on a period of time starting from the first time instance and ending at the second time instance.

This scheme improves user experience, at least for the reason that there is no need to terminate the connection to change MAC address. This scheme can also reduce overhead, because there is no need to send excessive signaling messages such as disassociate/re-associate frames to change MAC address, specific management/data frames to identify STA. Moreover, since this scheme can work for both pre-association and post-association, the network compatibility is ensured. As such, it is allowed to support services between MAC layer and upper layers.

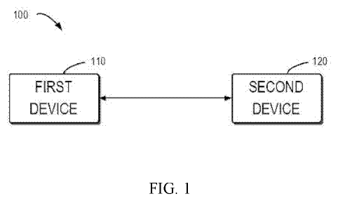

FIG. 1 illustrates an example environment 100 in which example embodiments of the present disclosure can be implemented.

The environment 100, which may be a part of a communication network, comprises two devices 110 and 120 communicating with each other or with other devices via each other. For the purpose of discussion, the devices 110 and 120 may be referred to as a first device 110 and a second device 120, respectively.

The first and second devices 110 and 120 may be implemented by any suitable devices in the communication network. In some example embodiments, the first device 110 may be implemented by a terminal device and the second device 120 may be implemented by a network device, or vice versa. In some other example embodiments, the first and second devices 110 and 120 may be both implemented by terminal devices or network devices. Just for the purpose of discussion, in some example embodiments, the terminal device will be taken as an example of the first device 110, and the network device will be taken as an example of the second device 120, and in some other example embodiments, the network device will be taken as an example of the first device 110, and the terminal device will be taken as an example of the second device 120.

It is to be understood that two devices are shown in the environment 100 only for the purpose of illustration, without suggesting any limitation to the scope of the present disclosure. In some example embodiments, the environment 100 may comprise a further device to communicate with the first device 110 and/or the second device 120.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

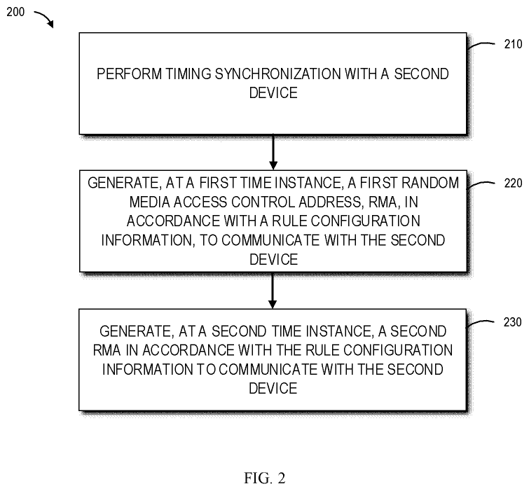

FIG. 2 illustrates a flowchart of an example method 200 according to some example embodiments of the present disclosure. The method 200 can be implemented by the first device 110 as shown in FIG. 1. For the purpose of discussion, the method 200 will be described with reference to FIG. 1. In some example embodiments, the first device 110 may be implemented by a terminal device, such as a STA, and the second device 120 communicating with the first device 110 may be implemented by a network device, such as an AP. In some other example embodiments, the first device 110 may be implemented by a network device, such as an AP, and the second device 120 communicating with the first device 110 may be implemented by a terminal device, such as a STA.

In some example embodiments, capability information associated with RMA generation of the first device 110 or the second device 120 may be determined. For example, the capability information may comprise at least one of: at least one rule for the RMA generation, or at least one indication of supported timing synchronization approach.

As an example, the timing synchronization approach may comprise implementing the timing synchronization by synchronizing with a time obtained from a further device, such as the internet time. As another example, the timing synchronization approach may be associated with timing synchronization function (TSF) information. For example, the first device 110 may obtain the TSF information from the second device 120.

The rule for RMA generation may be determined in variety of means. For example, the rule for RMA generation may be associated at least with timing information so as to allow synchronous change of the RMA at the first device 110 and the second device 120 for device identification. In some example embodiments, the rule may be defined to associate RMA generation with the timing information. For example, the RMA at the time instance of generating the RMA (for example, t) for a given rule may be generated based on a given random function taking the time instance of generating the RMA t as the input parameter, i.e., RMA(t)=rule(t). As an example, at a time instance (also referred to as a first time instance), the RMA may be calculated by using the first time instance as an input parameter, which can be denoted as rule(first time instance), and then, at a later time instance (also referred to as a second time instance), the RMA may be calculated by using the second time instance as an input parameter, which can be denoted as rule(second time instance).

As an example, the RMA can be generated based on the following random function as shown in the following equation (1):

$$RMA ( t ) = randi ( i max , [ 1 , n ] , “ seed ” , t ) \qquad ( 1 )$$

where randi(imax, [1, n], “seed”, t) is to create a 1-by-n co-distributed vector of uniformly distributed random integers in the range defined by imax, and the seed for the randomization operation is specified by the time instance of generating the RMA t. As an example, the imax, n may be set to 255 and 6 respectively to generate a RMA. Furthermore, each integer in the vector may correspond to one byte of the RMA.

As another example, an MAC address pool including a set of candidate MAC addresses may be used to generate the RMA. In this case, the RMA at the time instance of generating the RMA (for example, t) may be randomly selected from the configured MAC address pool taking the time instance of generating the RMA as the random seed for RMA generating, for example, as shown in the following equation (2):

$$RMA ( t ) = MAC\_POOL ( randi ( i max , 1 , ‘ seed ’ , t ) \qquad ( 2 )$$

where randi(imax, 1, “seed”, s) is to create a uniformly distributed random integer in the range defined by imax, and the seed for the randomization operation is specified by the time instance of generating the RMA t. As an example, the imax may be the number of MAC addresses in the MAC address pool, and the seed for the randomization operation may be specified by the time instance of generating the RMA t.

In some other example embodiments, the rule may be defined to associate the RMA generation with the timing information and at least one reference identifier. For example, the reference identifier may be a RMA, a public key, a private key, a shared key generated by a temporal key (TK), a pairwise transient key (PTK) or a pairwise master key (PMK) on both sides, a signature, a device identifier or any identifier which is used for RMA generation and STA identification. In the embodiments where one of the first device 110 and the second device 120 is implemented by a STA and the other is implemented by an AP, the reference identifier may be the MAC address of the STA/AP carried in the MAC header, or the RMA determined when the STA associates with AP for the first time.

As an example, the RMA at the time instance of generating the RMA (for example, t) may be generated based on a random function taking the time instance of generating the RMA and the reference identifiers ref_id(k) (k=1, . . . , K, where K is the number of identifiers) as the input parameters, i.e., RMA(t)=rule(ref_id(1), . . . , ref_id(K), t).

For example, it may be assumed that the reference identifier is the MAC address of STA in the MAC header, the RMA at the timing point of generating the RMA t (for example, RMA(t)) may be generated based on the latest RMA of STA in the MAC header (for example, RMA(t−1)). In this case, two example rule definitions may be given as below:

$$RMA ( t ) = RMA ( t - 1 ) + 1 \qquad ( 3 )$$

$$RMA ( t ) = RMA ( t - 1 ) + X ( t ) \qquad ( 4 )$$

where X(t) is a random MAC address generated based on the timing information.

As an example, two reference identifiers may be configured for the RMA generation. In the embodiments where one of the first device 110 and the second device 120 is implemented by a STA and the other is implemented by an AP, a first reference identifier may be the RMA of the STA which is determined when the STA associated with the AP for the first time and the second identifier may be the MAC address of the AP. In this case, the rule may be defined as below:

$$RMA of STA ( t ) = RMA of STA ( t - 1 ) + X ( t , MAC Address of AP ) \qquad ( 5 )$$

where t denotes the time instance of generating the RMA, and the X is a random function to generate a RMA based on the time instance t and the MAC address of the AP.

In some example embodiments, the rule(s) may be pre-defined in the specification. Alternatively or in addition, the rule(s) may be specified through rule configuration information, which will be described in details in the following.

In some example embodiments, the first device 110 may receive, from the second device 120, capability information of the second device 120 associated with RMA generation.

As an example, the second device 120 may proactively advertise the capability information, for example through a beacon frame, a probe frame, an association frame, or an action frame. For example, in the embodiments where the second device is implemented by a terminal device, it may transmit its capability information in the probe request frame. Alternatively, in the embodiments where the second device is implemented by a network device, it may advertise the capability information in the probe response frame.

As another example, the first device 110 may transmit, to the second device 120, a request for the capability information of the second device 120. Then, in response, the second device 120 may transmit to the first device 110 the capability information of the second device 120. For example, the first device 110 may transmit an action frame to the second device 120 in order to request the capability information, and the second device 120 may transmit its capability information to the first device 110 through another action frame. Alternatively or in addition, the first device 110 may request and collect the capability information of the second device 120 in a security mode, for example, through the integrated Extensible Authentication Protocol over LAN (EAPOL) frames or (re) association frames.

Then, the first device 110 may determine the rule configuration information for RMA generation at least partially based on the capability information of the second device 120. Further, the first device 110 may transmit to the second device 120 the rule configuration information.

In some other example embodiments, the first device 110 may transmit, to the second device 120, capability information of the first device 110 associated with RMA generation. Likewise, the first device 110 may proactively advertise its capability information to the second device 120 through a frame as described above. Alternatively, the first device 110 may transmit to the second device 120 its capability information in response to a request for the capability information of the first device 110 from the second device 120. Then, at least partially based on the received capability information of the first device 110, the second device 120 may determine the rule configuration information for RMA generation. Further, the second device 120 transmits to the first device the rule configuration information.

For example, the rule configuration information may be transmitted through an action frame. As another example, the rule configuration information may be transmitted in a security mode. For example, the rule configuration information may be transmitted through EAPOL frame or (re) association frame in Fast Initial Link Setup (FILS) mode.

In some example embodiments, the rule configuration information may be updated. As an example, the first device 110 or the second device 120 may initiate an update of the rule configuration information. For example, the first device 110 may receive, from the second device 120, a rule configuration update. Then, the first device 110 may update the rule configuration information based on the rule configuration update. In this case, the first device 110 may trigger a receiver to generate a RMA based on the configured rule through the rule configuration update where the triggering indication of RMA generation is activated. As another example, a periodicity can be configured in the rule configuration information and the first device 110 or the second device 120 may be triggered to periodically update the rule configuration.

For example, the above mentioned rule configuration information may comprise at least one of:
an indication of a determined rule from at least one supported rule for RMA generation;
an indication of an applicable association phrase, for indicating which association phrase the configured rule is used for, such as, at least one of: pre-association phrase, post-association phrase, or during associating;
one or more reference identifiers, for RMA generation and device identification, such as, a RMA, a public key, a private key, a shared key on both sides a signature; or a device identifier;
an indication of a timing synchronization approach;
an indication associated with activation of the determined rule;
an indication of a triggering of the RMA generation, for triggering the receiver to generate a RMA based on the configured rule; or
time information for the RMA generation.

As shown in FIG. 2, at block 210, the first device performs timing synchronization with the second device 120. In the embodiments where the rule configuration information comprises an indication of a timing synchronization approach associated with TSF information, the first device 110 may obtain timing TSF information from the second device 120. Then, the first device 110 may perform timing synchronization with the second device 120 based on the TSF information. As an example, the first device 110 may receive a beacon or/and probe response from the second device and then use the TSF information in these frames for timing synchronization. In the embodiments where the rule configuration information comprises an indication of a timing synchronization approach associated with a time from a third device, the first device 110 may obtain the time of the third device. Further, the first device 110 may perform timing synchronization with the second device 120 based on the time of the third device. As an example, the first device 110 and the second device 120 may synchronize their own time with the internet time respectively.

Alternatively or in addition, the timing synchronization approach may be determined based on at least the collected capability information of the first device 110 or the second device 120. For example, whether or not having ability to synchronize the internet time may be advertised through the capability information. In this case, if both the first device 110 and the second device 120 may synchronize their own timer with the internet time and the synchronization requirement is very high, the internet time may be selected as the baseline timer for timing synchronization. If neither the first device 110 nor the second device 120 may synchronize its timer with the internet time, the TSF information may be considered for the timing synchronization.

After performing timing synchronization with the second device 120, the first device 110 may generate a RMA based on the rule configuration information. As shown in FIG. 2, at block 220, the first device 110 generates, at a first time instance, a first RMA, in accordance with a rule configuration information, to communicate with the second device 120. Then, at block 230, the first device 110 generates, at a second time instance, a second RMA in accordance with the rule configuration information to communicate with the second device 120. In this case, the rule configuration information comprises time instructions comprising information corresponding to the first time instance, and information on a period of time starting from the first time instance and ending at the second time instance. In some example embodiments, the first RMA and the second RMA may be carried in different frames. For example, the first RMA may be carried in a probe request frame, while the second RMA may be carried in an authentication and (re) association frame.

For example, at least the timing information may be used as an input parameter to generate the RMA. In this case, the first device 110 may generate the RMA based on the indication of a determined rule comprised in the rule configuration information by using the timing information as an input parameter. In the example embodiments where the rule configuration information further comprises one or more reference identifiers, that is, the determined rule is associated with the one or more reference identifiers and the timing information, the first device 110 may generate the RMA based on the timing information and the one or more reference identifiers. For example, the first device 110 may generate the first RMA by using the first time instance and the one or more reference identifiers as input parameters and generate the second RMA by using the second time instance and the one or more reference identifiers as input parameters.

In some example embodiments, the first device 110 may generate the RMA periodically. In the example embodiments where the rule configuration information comprise time information for the RMA generation, which indicates a starting time instance and an period for periodical RMA generation, the first device 110 may determine a time instance for the RMA generation based on the starting time instance and the period for periodical generation of subsequent RMA(s). Furthermore, for example, the time instance of generating the RMA may also be used as a random seed for RMA generation. Likewise, the second device 120 may generate the RMA periodically. Thus, in this case, as the first device 110 and the second device 120 are time synchronized, both the first device 110 and the second device 120 may generate and store the RMA periodically at the same time instance of generating the RMA based on rule configuration information. For example, it is assumed that the starting time is 1:00 AM and the period is 20 minutes, and then the first device 110 and the second device 120 may generate a RMA at the 0th minute, 20th minute, 40th minute per hour.

In some example embodiments, the second device 120 may transmit to the first device 110 a triggering indication of RMA generation by updating the rule configuration through, for example, an action frame or a beacon frame, so as to trigger the first device 110 to generate a RMA based on the configured rule. Then, in response, the first device 110 may generate the RMA correspondingly.

Then, the first device 110 may communicate with the second device 120 with the current RMA. For example, the first device may receive, from the second device 120, a target RMA. Then, the first device 110 may identify the second device 120 based on a comparison between the current RMA and the target RMA. In the embodiments where the target RMA is determined at least based on at least one reference identifier and the timing information, the first device 110 may identify the second device 120 based on the comparison between the current RMA and the target RMA and an association between the target RMA and the at least one reference identifier. In this case, to communicate with the first device 110, the second device 120 may, for the first device 110, determine the target RMA based on the configured rule associated with the at least one reference identifier and the timing information. Then, the second device 120 may transmit to the first device 110 the determined target RMA for communication. At the first device 110, it may compare the received target RMA with the current RMA generated at the first device 110, and on the basis that the target RMA is the same as the current RMA, it may further identify the second device 120 based on an association between the target RMA and the at least one reference identifier.

In the embodiments where the first device 110 is implemented by an AP and the second device is implemented by a STA, the second device may use the last stored RMA as the Source Address (SA)/Transmitter Address (TA) for communication with the first device 110. And then the first device 110 may check if the SA/TA is the same as one of stored RMAs. If so, the first device 110 may further recognize which STA the RMA is associated with, otherwise, it may treat the second device 120 as an invalid STA.

In the embodiments where the first device 110 is implemented by a STA and the second device is implemented by an AP, the second device 120 may use the last stored RMA of the first device 110 as the Destination Address (DA)/Receiver Address (RA) for the communication. Upon receiving a frame from the second device 120, the first device 110 may check if the DA/RA in the frame is the same as one of stored RMAs. If so, the first device 110 may consider that it is a valid unicast frame, otherwise, the first device 110 may consider that it is an invalid unicast frame.

In some example embodiments, both the first device 110 and the second device 120 may store multiple RMAs, and then the multiple RMAs may be applied for the above procedures. As an example, after changing the RMA, the first device 110 may send to the second device 120 a signaling to indicate the change of RMA. After the second device 120 acknowledges such change, the first device 110 and the second device 120 may use the recent one of multiple RMAs stored at each side for subsequent communication. That is, the second device 120 may transmit to the first device 110 a recent RMA (also referred to as a target RMA) of the multiple RMA stored at the second device 120. Then, the first device 110 may compare the received target RMA with a recent locally generated RMA of the multiple RMAs stored at the first device 110. If the received target RMA is not the same as the recent locally generated RMA, the first device 110 may further compare the received target RMA with the other RMAs of the multiple RMAs stored at the first device 110. And if the received target RMA is the same as one of the multiple RMAs stored at the first device 110, the first device 110 may communicate with the second device 120. In this case, even if there is an error for the timing synchronization between the first device 110 and the second device 120, the communication between the first device 110 and the second device 120 may not be impacted.

For example, for multi-AP operation in the same ESS, it's possible for an STA within the ESS to switch from a serving AP to a target AP. The following example embodiments can be considered for timing synchronization between the STA and the target AP. In some example embodiments, the rule configuration information may be shared among multiple APs within the same ESS, thus the STA may use the TSF information of the target AP for generating the RMA to associate with the target AP if the configured rule is activated and the timing synchronization approach associated with the TSF information is configured. In some other embodiments, the rule configuration information may be shared among the multiple APs within the same ESS, and the STA may use the internet time for generating the RMA to associate with the target AP if the configured rule is activated and the timing synchronization approach associated with the internet time is configured. As an example embodiment, a Distributed System (DS) may determine the rule configuration information and then share the rule configuration information among the multiple APs within the ESS.

In this way, user experience is improved, for the reason that there is no need to terminate the connection to change MAC address. Besides, it is also allowed to reduce overhead, because there is no need to send excessive signaling messages such as disassociate/re-associate frames to change MAC Address, specific management/data frames to identify STA. Moreover, since this scheme works for both pre-association and post-association, the network compatibility is ensured. As such, it is allowed to support services between MAC layer and upper layers.

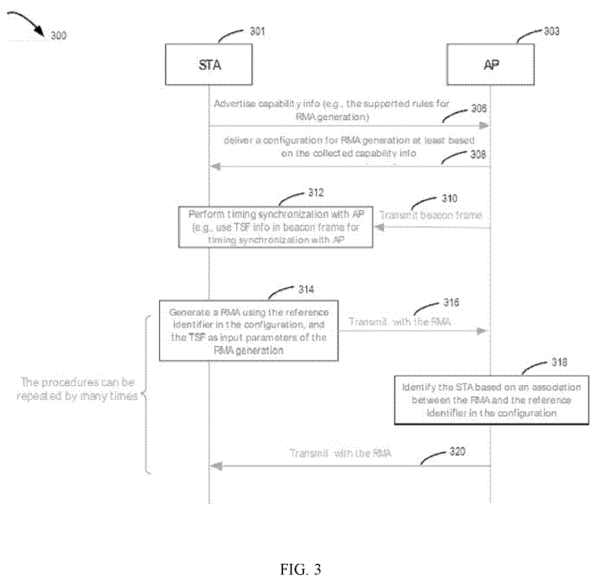

FIG. 3 illustrates a signaling flow 300 between the first device and the second device according to some example embodiments of the present disclosure. For the purpose of discussion, the signaling flow 300 will be described with reference to FIG. 1. In this case, the first device 110 is implemented by a STA 301, and the second device 120 is implemented by an AP 303.

As shown in FIG. 3, at 306, the STA 301 to the AP 303 advertises the capability information at least including the rule-based mechanism(s) for RMA generation. Then, the AP 303 may determine a configuration for RMA generation at least based on the collected capability information. For example, the configuration may comprise such as an indication of a determined rule (for example, an indication indicating that the determined rule is defined to associate the RMA generation with the timing information and a reference identifier), an indication of an applicable association phrase (for example, the post-association phase), a reference identifier, an indication of timing synchronization approach (for example, an indication of timing synchronization approach associated with the TSF information), and an indication associated with activation of the determined rule (for example, activation indication). At 308, the AP 303 transmits to the STA 301 the configuration for RMA generation.

At 310, the AP 303 transmits to the STA 301 a beacon frame comprising TSF information. Then, at 312, STA 301 performs timing synchronization with the AP 303 based on the TSF information in the beacon frame for timing synchronization with the AP 301.

At 314, the STA 301 generates a RMA using the reference identifier in the configuration and the TSF information as input parameters of the RMA generation. Then, at 316, the STA 301 transmits to the AP 303 with the RMA. At 318, the AP 303 identifies the STA 301 based on an association between the RMA and the reference identifier in the configuration. Then, at 320, the AP 303 transmits to the STA 301 with the RMA.

All operations and features as described above with reference to FIG. 2 are likewise applicable to the signaling flow 300 and have similar effects. For the purpose of simplification, the details will be omitted.

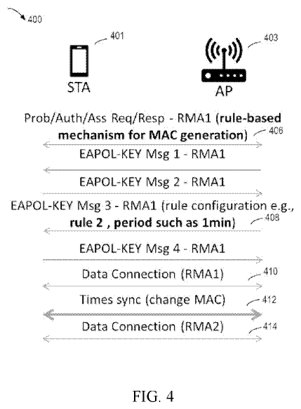

FIG. 4 illustrates an example process 400 for periodical RMA generation according to some example embodiments of the present disclosure. For the purpose of discussion, the process 400 will be described with reference to FIG. 1. In this case, the first device 110 is implemented by a STA 401, and the second device 120 is implemented by an AP 403.

As shown in FIG. 4, at 406, the STA 401 may advertise its capability information at least including the rule-based mechanism for RMA generation (for example, rule 1 and rule 2) and the ability to synchronize the internet time (for example, not supported).

Based on the collected capability information from the STA 401, the AP 403 may determine the rule configuration information including such as an indication of a determined rule (for example, rule 2), an indication of an applicable association phrase (for example, the post-association phase), a reference identifier (for example, RMA1), time information for the RMA generation (for example, a starting time instance and an interval of RMA generation, such as, zero clock and 1 minute, respectively), an indication of timing synchronization approach (for example, an indication of timing synchronization approach associated with the TSF information), and an indication associated with activation of the determined rule (for example, activation indication).

At 408, the AP 403 transmits the rule configuration information to the STA 401 through EAPOL-KEY Message 3 (Msg.3) during 4-way handshake. Upon receiving the rule configuration information, the STA 401 may manage to receive the beacon from the AP. And then the STA 401 may take the TSF in the beacon frame as the baseline timer for timing synchronization.

After that, both the STA 401 and the AP 403 may generate RMA periodically at the same time for communication after association according to the rule configuration information. For example, at 410, the STA 401 uses RMA1 to build connection with the AP 403 at first. After it is time to generate RMA at 412, both the STA 401 and the AP 403 generate a new RMA (i.e., RMA2) to perform communication between them as shown at 414.

All operations and features as described above with reference to FIG. 2 are likewise applicable to the process 400 and have similar effects. For the purpose of simplification, the details will be omitted.

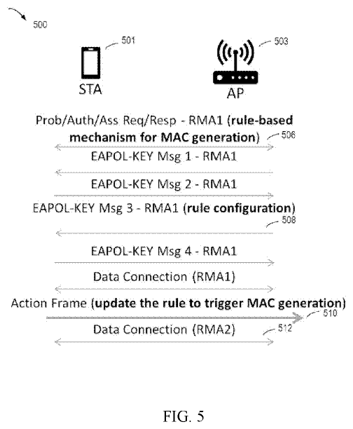

FIG. 5 illustrates an example process 500 for STA-triggered RMA generation according to some example embodiments of the present disclosure. For the purpose of discussion, the process 500 will be described with reference to FIG. 1. In this case, the first device 110 is implemented by a STA 501, and the second device 120 is implemented by an AP 503.

As shown in FIG. 5, at 506, the STA 501 may advertise its capability info at least including the rule-based mechanism for RMA generation (for example, rule 1, rule 2 and rule 3) and the ability to synchronize the internet time (for example, not supported).

Based on the collected capability information from the STA 501, the AP 503 may determine the rule configuration information including such as an indication of a determined rule (for example, the rule 2), an indication of an applicable association phrase (for example, both the pre-association and post-association phases), a reference identifier (for example, RMA1), an indication of timing synchronization approach (for example, an indication of timing synchronization approach associated with the TSF information), and an indication associated with activation of the determined rule (for example, activation indication).

At 508, the AP 503 transmits the rule configuration information to the STA 501 through EAPOL-KEY Msg.3 during 4-way handshake. Upon receiving the rule configuration information, the STA 501 may manage to receive the beacon from the AP. And then the STA 501 may take the TSF in the beacon frame as the baseline timer for timing synchronization.

At 510, the STA 501 transmits a triggering indication of RMA generation to the AP 503 by updating the rule configuration through for example an action frame, so as to trigger the AP 503 to generate a RMA based on the configured rule. Alternatively, the starting time of RMA generation may also be specified in the updated rule configuration information so as to ensure both the STA 501 and the AP 503 to generate the RMA at the same time according to the rule configuration information. For example, the STA 501 may use RMA1 to build connection with the AP 503 at first. After the STA 501 updates the rule configuration information to trigger RMA generation, both the STA 501 and the AP 503 may generate a new RMA (i.e., RMA2) to perform communication between them at the specified starting time of generating the RMA as shown at 512.

All operations and features as described above with reference to FIG. 2 are likewise applicable to the process 500 and have similar effects. For the purpose of simplification, the details will be omitted.

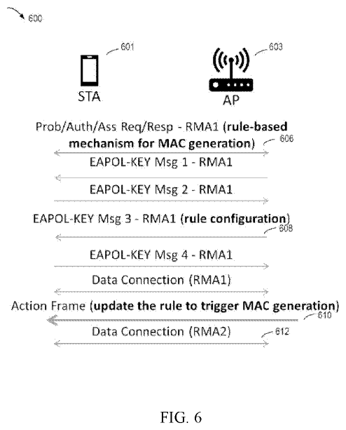

FIG. 6 illustrates an example process 600 for AP-triggered RMA generation according to some example embodiments of the present disclosure. For the purpose of discussion, the process 600 will be described with reference to FIG. 1. In this case, the first device 110 is implemented by a STA 601, and the second device 120 is implemented by an AP 603.

As shown in FIG. 6, at 606, the AP 603 may request the STA 601 to report its capability information about the rule-based mechanism for RMA generation in an action frame. Upon receiving the request, the STA 601 may advertise its capability information at least including the rule-based mechanism for RMA generation (for example, rule 1, rule 2 and rule 3) and the ability to synchronize the internet time (for example, supported).

Based on the collected capability information from the STA 601, the AP 603 may determine the rule configuration information including such as an indication of a determined rule (for example, the rule 1), an indication of an applicable association phrase (for example, both the pre-association and post-association phases), a reference identifier (for example, RMA in the MAC header), an indication of timing synchronization approach (for example, an indication of timing synchronization approach associated with the internet time), and an indication associated with activation of the determined rule (for example, activation indication).

At 608, the AP 603 transmits the rule configuration information to the STA 601 through EAPOL-KEY Msg.3 during 4-way handshake. Upon receiving the rule configuration information, the STA 601 may manage to synchronize its timer with the internet time for timing synchronization with the AP 603.

At 610, the AP 603 transmits a triggering indication of RMA generation to the STA 601 by updating the rule configuration information through for example an action frame, so as to trigger the STA 601 to generate a RMA based on the configured rule. Alternatively, the starting time of RMA generation may also be specified in the updated rule configuration information so as to ensure both the STA 601 and the AP 603 to generate the RMA at the same time according to the rule configuration information. For example, the STA 601 may use RMA1 to build connection with the AP 603 at first. After the AP 603 updating the rule configuration information to trigger RMA generation, both the STA 601 and the AP 603 may generate a new RMA (i.e., RMA2) to perform communication between them at the specified starting time of generating the RMA as illustrated as shown at 612.

All operations and features as described above with reference to FIG. 2 are likewise applicable to the process 600 and have similar effects. For the purpose of simplification, the details will be omitted.

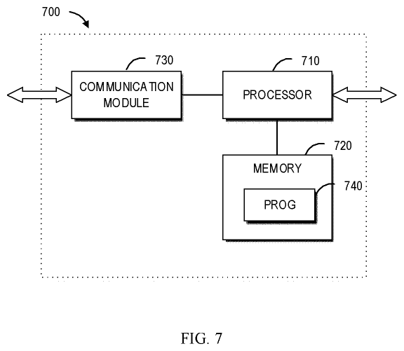

FIG. 7 is a simplified block diagram of a device 700 that is suitable for implementing example embodiments of the present disclosure. The device 700 can be implemented at or as a part of the first device 110 or the second device 120 as shown in FIG. 1.

As shown, the device 700 includes a processor 710, a memory 720 coupled to the processor 710, a communication module 730 coupled to the processor 710, and a communication interface (not shown) coupled to the communication module 730. The memory 720 stores at least a program 740. The communication module 730 is for bidirectional communications, for example, via multiple antennas. The communication interface may represent any interface that is necessary for communication.

The program 740 is assumed to include program instructions that, when executed by the associated processor 710, cause the device 700 to operate in accordance with the example embodiments of the present disclosure, as discussed herein with reference to FIGS. 1-6. The example embodiments herein may be implemented by computer software executable by the processor 710 of the device 700, or by hardware, or by a combination of software and hardware. The processor 710 may be configured to implement various example embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

When the device 700 acts as the first device 110 or a part of the first device 110, the processor 710 and the communication module 730 may cooperate to implement the method 200 as described above with reference to FIG. 2. All operations and features as described above with reference to FIGS. 1-6 are likewise applicable to the device 700 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 200 as described above with reference to FIG. 2. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprises: at a first device, performing timing synchronization with a second device; generating, at a first time instance, a first random media access control address, RMA, in accordance with a rule configuration information, to communicate with the second device; generating, at a second time instance, a second RMA in accordance with the rule configuration information to communicate with the second device. The rule configuration information comprises time instructions comprising information corresponding to the first time instance, and information on a period of time starting from the first time instance and ending at the second time instance.

In some example embodiments, the method further comprises: transmitting, to the second device, capability information of the first device associated with RMA generation; and receiving, from the second device, the rule configuration information, the rule configuration information being determined by the second device at least partially based on the capability information of the first device.

In some example embodiments, the method further comprises: receiving, from the second device, a request for the capability information of the first device.

In some example embodiments, the method further comprises: receiving, from the second device, capability information of the second device associated with the RMA generation; determining the rule configuration information at least partially based on the capability information of the second device; and transmitting, to the second device, the rule configuration information.

In some example embodiments, the method further comprises: transmitting, to the second device, a request for the capability information of the second device.

In some example embodiments, the method further comprises: receiving, from the second device, a rule configuration update; and updating the rule configuration information based on the rule configuration update.

In some example embodiments, the capability information comprises at least one of: at least one rule for RMA generation; or at least one indication of supported timing synchronization approach.

In some example embodiments, the rule configuration information further comprises at least one of: an indication of a determined rule from the at least one rule; an indication of an applicable association phrase; one or more reference identifiers; an indication of a timing synchronization approach; an indication associated with activation of the determined rule; or an indication of a triggering of the RMA generation.

In some example embodiments, the indication of the timing synchronization approach is associated with timing synchronization function, TSF, information, and performing timing synchronization with the second device comprises: obtaining the TSF information from the second device; and performing timing synchronization with the second device based on the TSF information.

In some example embodiments, the indication of the timing synchronization approach is associated with a time from a third device, and performing timing synchronization with the second device comprises: obtaining the time from the third device; and performing timing synchronization with the second device based on the time obtained from the third device.

In some example embodiments, wherein the indication of the applicable association phrase comprises at least one of: pre-association phrase; post-association phrase; or during associating.

In some example embodiments, the one or more reference identifiers comprise at least one of: a RMA; a public key; a private key; a shared key; a signature; or a device identifier.

In some example embodiments, the rule configuration information comprises one or more reference identifiers, and generating the first RMA comprises: generating the first RMA by using the first time instance and the one or more reference identifiers as input parameters; and generating the second RMA comprises: generating the second RMA by using the second time instance and the one or more reference identifiers as input parameters.

In some example embodiments, the method further comprises: receiving, from the second device, a target RMA; and identifying the second device based on a comparison between a current RMA and the target RMA.

In some example embodiments, the received target RMA is determined at least based on at least one reference identifier, and identifying the second device comprises: identifying the second device based on the comparison between the current RMA and the target RMA and an association between the target RMA and the at least one reference identifier.

In some aspects, a device comprises: at least one processor; and at least one memory including computer program code. The at least one memory and the computer program code are configured to, with the at least one processor, cause the device to: performing timing synchronization with a second device; generating, at a first time instance, a first random media access control address, RMA, in accordance with a rule configuration information, to communicate with the second device; generating, at a second time instance, a second RMA in accordance with the rule configuration information to communicate with the second device. The rule configuration information comprises time instructions comprising information corresponding to the first time instance, and information on a period of time starting from the first time instance and ending at the second time instance.

In some example embodiments, the device is further configured to: transmit, to the second device, capability information of the device associated with RMA generation; and receive, from the second device, the rule configuration information, the rule configuration information being determined by the second device at least partially based on the capability information of the device.

In some example embodiments, the device is further configured to: receive, from the second device, a request for the capability information of the device.

In some example embodiments, the device is further configured to: receive, from the second device, capability information of the second device associated with the RMA generation; determine the rule configuration information at least partially based on the capability information of the second device; and transmit, to the second device, the rule configuration information.

In some example embodiments, the device is further configured to: transmit, to the second device, a request for the capability information of the second device.

In some example embodiments, the device is further configured to: receive, from the second device, a rule configuration update; and update the rule configuration information based on the rule configuration update.

In some example embodiments, the capability information comprises at least one of: at least one rule for RMA generation: or at least one indication of supported timing synchronization approach.

In some example embodiments, the rule configuration information further comprises at least one of: an indication of a determined rule from the at least one rule; an indication of an applicable association phrase; one or more reference identifiers; an indication of a timing synchronization approach; an indication associated with activation of the determined rule; or an indication of a triggering of the RMA generation.

In some example embodiments, the indication of the timing synchronization approach is associated with timing synchronization function, TSF, information, and the device is caused to perform timing synchronization with the second device by: obtaining the TSF information from the second device; and performing timing synchronization with the second device based on the TSF information.

In some example embodiments, the indication of the timing synchronization approach is associated with a time from a third device, and the device is caused to perform timing synchronization with the second device by: obtaining the time from the third device; and performing timing synchronization with the second device based on the time obtained from the third device.

In some example embodiments, the indication of the applicable association phrase comprises at least one of: pre-association phrase; post-association phrase; or during associating.

In some example embodiments, the one or more reference identifiers comprise at least one of: a RMA; a public key; a private key; a shared key; a signature; or a device identifier.

In some example embodiments, the rule configuration information comprises one or more reference identifiers, and the device is caused to generate the first RMA by: generating the first RMA by using the first time instance and the one or more reference identifiers as input parameters; and the device is caused to generate the second RMA by: generating the second RMA by using the second time instance and the one or more reference identifiers as input parameters.

In some example embodiments, the device is further configured to: receive, from the second device, a target RMA; and identify the second device based on a comparison between a current RMA and the target RMA.

In some example embodiments, the received target RMA is determined at least based on at least one reference identifier, and the device is caused to identify the second device by: identifying the second device based on the comparison between the current RMA and the target RMA and an association between the target RMA and the at least one reference identifier.

In some aspects, an apparatus comprises: means for performing timing synchronization with a second apparatus; means for generating, at a first time instance, a first random media access control address, RMA, in accordance with a rule configuration information, to communicate with the second apparatus; means for generating, at a second time instance, a second RMA in accordance with the rule configuration information to communicate with the second apparatus. The rule configuration information comprises time instructions comprising information corresponding to the first time instance, and information on a period of time starting from the first time instance and ending at the second time instance.

In some example embodiments, the apparatus further comprises: means for transmitting, to the second apparatus, capability information of the apparatus associated with RMA generation; and means for receiving, from the second apparatus, the rule configuration information, the rule configuration information being determined by the second apparatus at least partially based on the capability information of the apparatus.

In some example embodiments, the apparatus further comprises: means for receiving, from the second apparatus, a request for the capability information of the apparatus.

In some example embodiments, the apparatus further comprises: means for receiving, from the second apparatus, capability information of the second apparatus associated with the RMA generation: means for determining the rule configuration information at least partially based on the capability information of the second apparatus; and means for transmitting, to the second apparatus, the rule configuration information.

In some example embodiments, the method further comprises: means for transmitting, to the second apparatus, a request for the capability information of the second apparatus.

In some example embodiments, the method further comprises: means for receiving, from the second apparatus, a rule configuration update; and means for updating the rule configuration information based on the rule configuration update.

In some example embodiments, the capability information comprises at least one of: at least one rule for RMA generation: or at least one indication of supported timing synchronization approach.

In some example embodiments, the rule configuration information further comprises at least one of: an indication of a determined rule from the at least one rule; an indication of an applicable association phrase; one or more reference identifiers; an indication of a timing synchronization approach; an indication associated with activation of the determined rule; or an indication of a triggering of the RMA generation.

In some example embodiments, the indication of the timing synchronization approach is associated with timing synchronization function, TSF, information, and the means for performing timing synchronization with the second apparatus comprises: means for obtaining the TSF information from the second apparatus; and means for performing timing synchronization with the second apparatus based on the TSF information.

In some example embodiments, the indication of the timing synchronization approach is associated with a time from a third device, and the means for performing timing synchronization with the second apparatus comprises: means for obtaining the time from the third device; and means for performing timing synchronization with the second apparatus based on the time obtained from the third device.

In some example embodiments, wherein the indication of the applicable association phrase comprises at least one of: pre-association phrase; post-association phrase; or during associating.

In some example embodiments, the one or more reference identifiers comprise at least one of: a RMA; a public key; a private key; a shared key; a signature; or a device identifier.

In some example embodiments, the rule configuration information comprises one or more reference identifiers, and the means for generating the first RMA comprises: means for generating the first RMA by using the first time instance and the one or more reference identifiers as input parameters; and the means for generating the second RMA comprises: means for generating the second RMA by using the second time instance and the one or more reference identifiers as input parameters.

In some example embodiments, the apparatus further comprises: means for receiving, from the second apparatus, a target RMA; and means for identifying the second apparatus based on a comparison between a current RMA and the target RMA.

In some example embodiments, the received target RMA is determined at least based on at least one reference identifier, and the means for identifying the second apparatus comprises: means for identifying the second apparatus based on the comparison between the current RMA and the target RMA and an association between the target RMA and the at least one reference identifier.

In some aspects, a computer readable storage medium comprises program instructions stored thereon, the instructions, when executed by a processor of a device, causing the device to perform the method according to some example embodiments of the present disclosure.

1-32. (canceled)

33. A method comprising:
at a first device,
performing timing synchronization with a second device;
generating, at a first time instance, a first random media access control address, RMA, in accordance with a rule configuration information, to communicate with the second device;
generating, at a second time instance, a second RMA in accordance with the rule configuration information to communicate with the second device;
wherein the rule configuration information comprises time instructions comprising information corresponding to the first time instance, and information on a period of time starting from the first time instance and ending at the second time instance.

34. The method of claim 33, further comprising:
transmitting, to the second device, capability information of the first device associated with RMA generation; and
receiving, from the second device, the rule configuration information, the rule configuration information being determined by the second device at least partially based on the capability information of the first device.

35. The method of claim 34, further comprising:
receiving, from the second device, a request for the capability information of the first device.

36. The method of claim 33, further comprising:
receiving, from the second device, capability information of the second device associated with the RMA generation;
determining the rule configuration information at least partially based on the capability information of the second device; and
transmitting, to the second device, the rule configuration information.

37. The method of claim 36, further comprising:
transmitting, to the second device, a request for the capability information of the second device.

38. The method of claim 33, further comprising:
receiving, from the second device, a rule configuration update; and
updating the rule configuration information based on the rule configuration update.

39. The method of claim 34, wherein the capability information comprises at least one of:
at least one rule for RMA generation; or
at least one indication of supported timing synchronization approach.

40. The method of claim 39, wherein the rule configuration information further comprises at least one of:
an indication of a determined rule from the at least one rule;
an indication of an applicable association phrase;
one or more reference identifiers;
an indication of a timing synchronization approach;
an indication associated with activation of the determined rule; or
an indication of a triggering of the RMA generation.

41. The method of claim 40, wherein the indication of the timing synchronization approach is associated with timing synchronization function, TSF, information, and wherein performing timing synchronization with the second device comprises:
obtaining the TSF information from the second device; and
performing timing synchronization with the second device based on the TSF information.

42. A device, comprising:
at least one processor; and
at least one memory including computer program code;
the at least one memory and the computer program code configured to, with the at least one processor, cause the device to:
perform timing synchronization with a second device;
generate, at a first time instance, a first random media access control address, RMA, in accordance with a rule configuration information, to communicate with the second device;
generate, at a second time instance, a second RMA in accordance with the rule configuration information to communicate with the second device;
wherein the rule configuration information comprises time instructions comprising information corresponding to the first time instance, and information on a period of time starting from the first time instance and ending at the second time instance.

43. The device of claim 42, further configured to:
transmit, to the second device, capability information of the device associated with RMA generation; and
receive, from the second device, the rule configuration information, the rule configuration information being determined by the second device at least partially based on the capability information of the device.

44. The device of claim 43, further configured to:
receive, from the second device, a request for the capability information of the device.

45. The device of claim 42, further configured to:
receive, from the second device, capability information of the second device associated with the RMA generation;
determine the rule configuration information at least partially based on the capability information of the second device; and
transmit, to the second device, the rule configuration information.

46. The device of claim 45, further configured to:
transmit, to the second device, a request for the capability information of the second device.

47. The device of claim 42, further configured to:
receive, from the second device, a rule configuration update; and
update the rule configuration information based on the rule configuration update.

48. The device of claim 43, wherein the capability information comprises at least one of:
at least one rule for RMA generation; or
at least one indication of supported timing synchronization approach.

49. The device of claim 48, wherein the rule configuration information further comprises at least one of:
an indication of a determined rule from the at least one rule;
an indication of an applicable association phrase;
one or more reference identifiers;
an indication of a timing synchronization approach;
an indication associated with activation of the determined rule; or
an indication of a triggering of the RMA generation.

50. The device of claim 49, wherein the indication of the timing synchronization approach is associated with timing synchronization function, TSF, information, and wherein the device is caused to perform timing synchronization with the second device by:
obtaining the TSF information from the second device; and
performing timing synchronization with the second device based on the TSF information.

51. The device of claim 49, wherein the indication of the timing synchronization approach is associated with a time from a third device, and wherein the device is caused to perform timing synchronization with the second device by:
obtaining the time from the third device; and
performing timing synchronization with the second device based on the time obtained from the third device.

52. A computer readable storage medium comprising program instructions stored thereon, the instructions, when executed by a processor of a device, causing the device to perform the method of claim 33.
